(19) United States
(12) Patent Application Publication
(10) Pub. No.: US 2006/0235955 A1
(43) Pub. Date: Oct. 19, 2006

(54) Method and system for remote server administration

(75) Inventors: Xianfeng Chen, Mississauga (CA); Brindusa L. Fritsch, Toronto (CA); Michael Shenfield, Richmond Hill (CA)

Correspondence Address: OGILVY RENAULT LLP, 1981 MCGILL COLLEGE AVENUE, SUITE 1600, MONTREAL, QC, H3A2Y3, CA

(73) Assignee: Research in Motion Limited, Waterloo (CA)

(21) Appl. No.: 11/107,726

(22) Filed: Apr. 18, 2005

(51) Int. Cl. G06F 15/173

(52) U.S. Cl. 709/223

(57) ABSTRACT

Methods and systems for enabling remote server administration using a terminal device of a wireless network. The terminal device is hosted by an application gateway designed to mediate signalling between the terminal device and web services of a data network. A web service implementing administration functionality for one or more managed server components (MSCs) is deployed on the network. A plurality of server administration applications is then installed on the terminal device. Each server administration application is designed to access the web service to provide a respective server management function.

### CROSS-REFERENCE TO RELATED APPLICATIONS

This is the first application filed in respect of the present application.

### MICROFICHE APPENDIX

Not Applicable.

### TECHNICAL FIELD

The present invention relates to wireless communications devices, and in particular to a method and system for remote server administration from a wireless terminal device.

### BACKGROUND OF THE INVENTION

The number and variety of wireless terminal devices, such as mobile telephones, personal computers and PDAs with wireless communication capabilities, self service kiosks and two-way pagers is rapidly increasing. Software applications which run on these devices increase their utility. For example, a mobile phone may include an application which retrieves the weather for a range of cities, or a PDA may include an application that allows a user to shop for groceries. These software applications take advantage of wireless connectivity to a data network (such as the internet) in order to provide timely and useful services to users.

Graphical User Interface (GUI) based server administration tools provide user-friendly interfaces for a system administrator to configure, manage, monitor, and trouble-shoot various servers. Web-based server administration is becoming increasingly popular because it provides a convenient way of enabling remote server management over a data network (e.g. the Internet). In comparison with traditional server administration tools, web based administration offers various benefits. For example, the server can be accessed and managed via a conventional browser interface, and does not require installation of specialized administration software on the “remote” terminal. As a result, the server can be accessed and managed from virtually any terminal having a connection to the network. Additionally, web-based administration applications can work with enterprise servers through standard Hypertext Transfer Protocol (HTTP) and Secure Hypertext Transfer Protocol (HTTPS) protocols. This simplifies communications, and improves security for network/firewall management, because no extra ports need to be opened and managed through the firewall. Encryption and basic authentication can be provided by HTTPS/HTTP protocols respectively. Finally, web-based administration application software can be easily developed using well known techniques and application development tools. A representative web-based server administration system is illustrated in FIG. 1.

As may be seen in FIG. 1, a typical web-based server administration application 2 can conveniently be built using a layered architecture, including web layer 4, a server administration layer 6 with administration logic, and managed servers or server components (MSCs) 8 that are linked to the server administration layer 6 for web-based administration. The web layer 4 is configured as a thin client which exposes a server administration interface to the data network 10 using standard hyper-text mark-up language (HTML). A system administrator using a remote browser 12 (such as, for example Microsoft Internet Explorer™) can then access the server administration interface to perform desired management functions in respect of any of the MSCs 8. As is well known in the art, a layered structure of this type has an advantage in that it enables separation of the interface and server administration functionality, so that each layer can be independently developed and maintained. Unlike a fat-client user interface (UI), such as is typically implemented in Java Swing or Windows™ applications, coding in HTML requires no knowledge of complicated application program interface (API) or computer programming languages.

However, web-based server administration tools suffer from a number of shortcomings. For example, web-based applications require a stable network (internet) connection. Additionally, web based administration tools with sophisticated HTML interfaces typically consume significant amounts of resources, such as memory and transmission bandwidth. A further limitation is that web based applications are based on a “Pull” technology, in which data (in this case, server status information) is downloaded to the remote terminal (browser) only in response to a “refresh” command from the remote terminal.

As a result of these factors, wireless terminal devices are typically unsuitable for web-based server administration. In particular, wireless networks tend to suffer from fade (signal attenuation) and temporary service interruptions (due to loss of signal), which interfere with the maintenance of a stable network (Internet) connection. Additionally, wireless networks frequently suffer from low transmission bandwidth, thereby limiting the usefulness of any application which generates a large amount of HTTP traffic. Furthermore, most wireless terminal devices lack sufficient resources (principally memory, but also including processor speed and the size/sophistication of the display screen) to effectively utilize complex HTML pages operating through a browser interface. Finally, the “Pull” technology of web-based applications means that a server administrator will only receive a system status update when they request it. This implies that the administrator might not be timely notified of a change in server status, which could be critical in an emergency situation. It is possible to mitigate this latter problem by designing the web-based application 2 to continuously refresh the browser window, but this increases network traffic and taxes the bandwidth capacity of the wireless network.

Accordingly, methods and systems enabling remote server administration from a wireless terminal device remains highly desirable.

### SUMMARY OF THE INVENTION

Accordingly, an object of the present invention is to provide methods and systems for remote server administration from a wireless terminal device.

Thus, an aspect of the present invention provides a method for enabling remote server administration using a terminal device of a wireless network. The terminal device is hosted by an application gateway which enables communications between the terminal device and back-end resources of a data network. A web service implementing administration functionality for one or more managed server components (MSCs) is deployed on the data network. A plurality of server administration applications is then installed on the terminal device. Each server administration application is designed to access the web service to provide a respective server management function.

### BRIEF DESCRIPTION OF THE DRAWINGS

Further features and advantages of the present invention will become apparent from the following detailed description, taken in combination with the appended drawings, in which:

FIG. 1 is a block diagram schematically illustrating a conventional web-based server administration system;

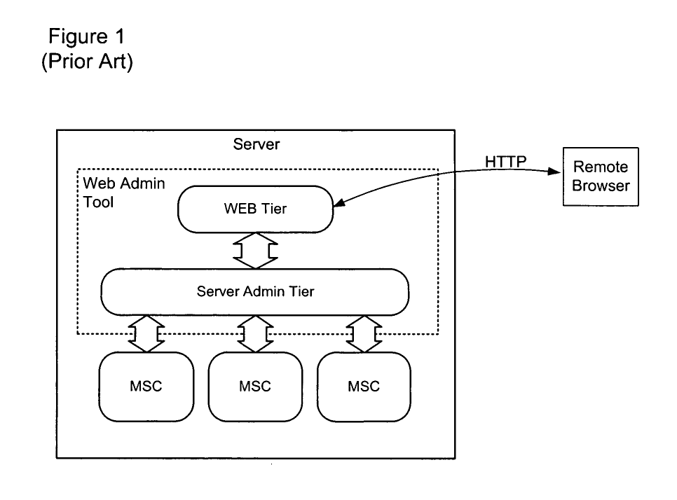

FIG. 2 is a block diagram schematically illustrating components and operation of a representative remote server administration system in accordance with an embodiment of the present invention;

It will be noted that throughout the appended drawings, like features are identified by like reference numerals.

### DETAILED DESCRIPTION OF THE PREFERRED EMBODIMENT

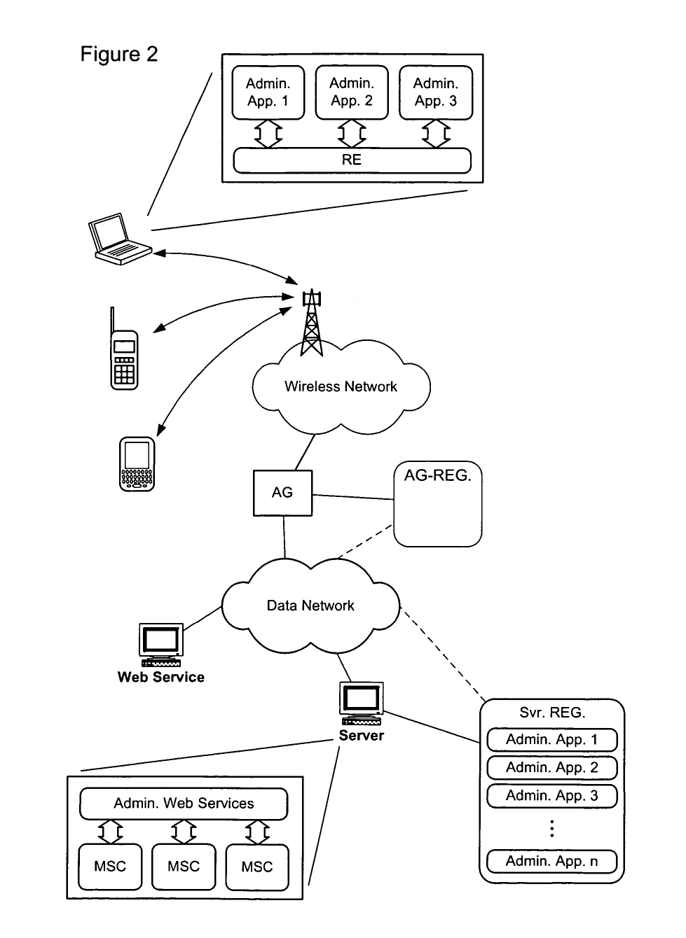

The present invention provides methods and systems for remote server administration from a wireless terminal device. A representative embodiment of the invention is described below, by way of example only, with reference to FIG. 2.

Referring to FIG. 2, a system in accordance with a representative embodiment of the present invention generally comprises an Application Gateway (AG) 14 coupled between a wireless network 16 and the data network 10, such as for example, the internet; a registry 18; a server system 20 coupled to the data network 10 to enable remote management; and one or more wireless terminal devices 22 coupled to the wireless network 16, and hosted by the AG 14.

The AG 14 generally operates to mediate message flows between the terminal devices 22 and data services accessible through the data network 10 in the manner described in Applicant's co-pending United States Patent Publications Nos. 2004/0215700 and 2004/0220998, the contents of both of which are incorporated herein by reference.

The registry 18, which can be co-resident with the AG 14 or may be located remotely from the AG 14 and accessed via the data network 10, generally comprises a profiles registry 24 and an applications registry 26. The profiles registry 24 contains, for each terminal device 22, a respective profile which contains information identifying each application installed on the terminal device 22. The applications registry 26 contains information identifying wireless applications that are available to the terminal devices 22, and the addresses (e.g. Universal Resources Look-ups—URLs) of respective back-end data sources and/or web services of the data network 10 that are accessed by each application.

In general, the terminal devices 22 can be any of a wide variety of software-controlled wireless devices including, but not limited to: mobile telephones; personal computers and PDAs with wireless communication capabilities; self service kiosks; and two-way pagers. As is well known in the art, such devices generally comprise a microprocessor which operates under software control to provide the functionality of the terminal device. As shown in FIG. 2, the software is preferably designed on a layered model, in which one or more wireless applications 28 control the user's experience of the terminal device 22, and a runtime environment (RE) 30 translates between the application software and the native machine-language of the terminal device 22 to control the terminal device hardware, and communicate with data services. This layered software model, and the manner in which it operates is known from Applicant's co-pending United States Patent Publications Nos. 2004/0215700 and 2004/0220998.

As described in Applicant's co-pending United States Patent Publications Nos. 2004/0215700 and 2004/0220998, operation of the AG 14 enables a wireless application 28 executing in a terminal device 22 to communicate with web services 32 offered through the data network 10. This operation may, for example, including accessing HTML content, and downloading files from back-end data sources (not shown) connected to the data network 10. In order to reduce device resource requirements, each wireless application 28 provides User Interface (UI) functionality (for both display and user input) appropriate to the capabilities of the particular terminal device 22. At least a portion of the application logic is executed on the AG 14 itself, so that signalling between the AG 14 and the terminal device 22 is limited to downloading application data to the terminal device 22 for local storage and display, and uploading user inputs. The application logic executing on the AG 14 communicates with the web service 32 or back-end data resource on the data network 10, in response to the user inputs received from the terminal device 22, to provide the functionality of wireless application 28. This arrangement enables a user of the terminal device 22 to access and use the web service's functionality, but with reduced signalling traffic to/from the terminal device 22 to thereby limit wireless network bandwidth and device resource requirements. In addition, the AG 14 is capable of implementing a generic subscription/notification function for application data that resides outside the AG 14. With this arrangement, the AG 14 subscribes to an event source (that is, a component of a Web service or back-end data source which is capable of generating notification events) on behalf of a wireless application 28 installed on a terminal device 22. Thereafter, the event source generates and sends Notification Events to the AG 14 in accordance with the subscription. As Notification Events are received by the AG 14, they are processed to determine the subscription(s) that they are associated with, and forwarded to the affected terminal device(s) 22, using, for example, the profiles registry 24 to identify the involved terminal device(s) 22.

In the illustrated embodiment, this functionality of the AG 14 is leveraged to enable remote server administration from a wireless terminal device 22. In particular, the that server administration functionality for one or more managed server components (MSCs) 8 is implemented as an administration web service 34, which is developed and deployed on the data network 10 using techniques well known in the art. One or more lightweight server administration wireless applications (server admin. applications) 36 are developed to implement server management functions as desired. The server admin. applications 36 can then be published and installed on the AG 14 and one or more terminal devices 22 according to actual system administration needs. Thereafter, the MSC's 8 can be monitored and managed from the terminal devices 22 by execution of the applicable server admin. application(s) 36.

In principle, all of the desired server management functions could be implemented within a single server admin. application 36. However, this solution would tend to produce an undesirably large application, which reduces the range of different terminal devices 22 on which it can be installed. Accordingly, it is preferable to publish a plurality of small server admin. applications, each of which provides a specific server management function and user permissions, and a UI flavour appropriate for a specific type of terminal device 22. In some cases, it may be convenient to store the complete set of server admin. applications 36 within a Server Registry 38, in which each server admin. application 36 is associated with information identifying the administration function(s) performed by that server admin. application 36 and either the UI flavour and/or the type(s) of terminal device(s) that can run the server admin. application 36. The Server Registry 38 may be associated with the server 20 itself, or may be maintained as a back-end resource connected to the data network 10. In either case, storing server admin. applications 36 within a server registry 38 in this manner allows server admin. applications 36 to be selected for download from the Server Registry 38 and installed on a terminal device 22 (and the AG 14), on an “as-needed” basis. The deployment of multiple such lightweight server admin. applications 36 enables a system administrator to manage the MSCs 8 using any of a variety of different terminal devices 22, by selecting, downloading and installing on each terminal device 22 those server admin. applications 36 having the appropriate combination of functionality, permissions and UI.

The solution of the present invention offers the following advantages:
server admin. applications 36 are lightweight and efficient, both on the server 20 and terminal devices 22. The present invention separates the invocation of administration web services 34 from the resulting display on a terminal device 22. As a result, the “Web Services” implementation of server administration functionality is only responsible for the actual server-side administration tasks; there is no need for the Web Service 34 to generate the UI presentation, which saves server resources and power.
In comparison with conventional web-based server administration, the illustrated embodiment provides a more flexible, balanced, and distributed solution. The design of a conventional web-based administration tool needs to take many factors into consideration, such as session management, authentication and authorization, etc., which increase the size and complexity of any “complete” web-based server administration tool. The mobile server solution of FIG. 2 enables a “complete” server administration solution through the use of multiple special purpose server admin. applications 36, and leverages the existing session management functionality of the AG 14.
With security wireless infrastructure support, secure communications between the AG 14 and the terminal device 22 can be guaranteed. An end-to-end secure solution can be obtained by placing the administration web service 34 behind a firewall (not shown), in a manner known in the art.
The wireless friendly “push” operation enabled by the subscription/notification function of the AG 14 means that server admin. applications 36 can be easily deployed to automatically receive notifications and alerts of server emergencies, which enables faster administration response time. Thus, for example, a server admin. application 36 installed on a terminal device 22 can subscribe to a notification service of the AG 14. Using the AG's generic subscription/notification functionality, the AG 14 then subscribes with the administration web service 34, on behalf of the server admin. application 36, to obtain notification events related to any changes (in any of the MSCs 8) that are relevant to the server admin. application 36. Any subsequently received notification events are automatically forwarded by the AG 14 to the server admin. application 36 running on the terminal device 22. In cases where the MSC 8 is the Application Gateway 14 itself (or a component thereof) a variation of the generic subscription/notification functionality can be implemented, in which changes that are relevant to the server admin. application 36 are passed to the server admin. application 36 without the generation and handling of a notification event per se. The use of the subscription/notification functionality of the AG 14 for event handling ensures that the user of the server admin. application 36 receives prompt notification of any changes in MSC status.

The embodiment(s) of the invention described above is(are) intended to be exemplary only. The scope of the invention is therefore intended to be limited solely by the scope of the appended claims.

We claim:

1. A method of enabling remote administration of one or more managed server components of a data network using a terminal device of a wireless network, the method comprising steps of:
providing an application gateway coupled to the data network (10) and the wireless network and hosting the terminal device, the application gateway being adapted to mediate signalling between the terminal device and web services of a data network;
installing a server administration application on the terminal device, the server administration application being adapted to control the terminal device to access an administration web service implementing administration functionality for the managed server components via the application gateway, so as to thereby provide a respective server management function.

2. A method as claimed in claim 1, wherein the step of installing a server administration application comprises steps of:
accessing a first plurality of server administration applications (38), each application within the first plurality of applications having a respective predetermined server management function and User Interface;
selecting, from the first plurality of applications, a second plurality of applications, each application within the second plurality of applications having a User Interface that matches a capability of the terminal device; and
installing at least one application from the second plurality of applications on the terminal device.

3. A method as claimed in claim 1, wherein a plurality of server administration applications are installed on the terminal device.

4. A method as claimed in claim 3, wherein each server administration application provides a respective specific server administration function.

5. A method as claimed in claim 1, wherein the server administration application comprises:
an application logic portion for execution on the application gateway;
a user interface portion for execution on the terminal device;
wherein the user interface portion is adapted to display application data received from the application logic portion, and to send user inputs to the application logic portion; and
wherein the application logic portion is responsive to the user inputs received from the user interface portion to interact with the administration web service to implement the respective server management function.

6. A method as claimed in claim 5, wherein the step of installing the server administration application on the terminal device comprises steps of:
downloading the user interface portion to the terminal device;
registering the downloaded user interface portion and the application logic portion on the application gateway, such that launching the downloaded user interface portion on the terminal device triggers execution of the application logic portion on the application gateway.

7. A method as claimed in claim 1, wherein the administration web service comprises an event source component designed to generate a notification event indicative of a predetermined change, and wherein the method further comprises a step of subscribing a server administration application installed on the terminal device with a subscription/notification function of the application gateway, such that the application gateway operates to:
subscribe with the event source of the administration web service (34) to receive notification events;
subsequently receive notification events from the event source;
process received notification events to identify notification events that are relevant to the server administration application; and
forward each identified notification event to the server administration application.

8. A terminal device of a wireless network adapted for remote administration of one or more managed server components of a data network, the terminal device being hosted by an application gateway coupled to the data network and the wireless network and adapted to mediate signalling between the terminal device and web services of the data network, the terminal device being characterised by:
a server administration application installed on the terminal device, the server administration application being adapted to control the terminal device to access an administration web service implementing administration functionality for the managed server components via the application gateway, so as to thereby provide a respective server management function.

9. A terminal device as claimed in claim 8, wherein a plurality of server administration applications are installed on the terminal device.

10. A terminal device as claimed in claim 9, wherein each server administration application provides a respective specific server administration function.

11. A terminal device as claimed in claim 8, wherein the server administration application comprises:
an application logic portion registered on the application gateway;
a user interface portion installed on the terminal device;
wherein the user interface portion is adapted to display application data received from the application logic portion, and to send user inputs to the application logic portion; and
wherein the application logic portion is responsive to the user inputs received from the user interface portion to interact with the administration web service to implement the respective server management function.

12. An application gateway adapted to enable remote administration of one or more managed server components of a data network using a terminal device of a wireless network, the application gateway comprising:
means for mediating signalling between a server administration application installed on the terminal device and an administration web service implementing administration functionality for the managed server components.

13. An application gateway as claimed in claim 12, wherein the server administration application comprises:
an application logic portion registered on the application gateway;
a user interface portion installed on the terminal device;
wherein the user interface portion is adapted to display application data received from the application logic portion, and to send user inputs to the application logic portion; and
wherein the application logic portion is responsive to the user inputs received from the user interface portion to interact with the administration web service to implement the respective server management function.

14. An application gateway, wherein the administration web service comprises an event source component designed to generate a notification event indicative of a predetermined change, and wherein the application gateway (14) further comprises:
a subscription/notification function; and
means for subscribing a server administration application installed on the terminal device with the subscription/notification function, such that the application gateway operates to:
subscribe with the event source of the administration web service to receive notification events;
subsequently receive notification events from the event source;
process received notification events to identify notification events that are relevant to the server administration application; and
forward each identified notification event to the server administration application.
